(19) United States
(12) Patent Application Publication
(10) Pub. No.: US 2015/0339027 A1
(43) Pub. Date: Nov. 26, 2015

(54) SYSTEMS, METHODS, AND COMPUTER-READABLE MEDIA FOR TOUCH-SCREEN TRACING INPUT

(71) Applicant: WOUNDMATRIX, INC., Chadds Ford, PA (US)

(72) Inventor: Osama H. AL-MOOSAWI, Bear, DE (US)

(21) Appl. No.: 14/719,675

(22) Filed: May 22, 2015

Related U.S. Application Data
(60) Provisional application No. 62/002,047, filed on May 22, 2014.

(51) Int. Cl. G06F 3/0488; G06F 3/041

(52) U.S. Cl. CPC G06F 3/0488; G06F 3/041

(57) ABSTRACT

Methods, systems, and computer-readable media for facilitating trace touch input through an input device of a computing system. The input device may include a touch-based input device, such as a touch screen input device. For example, some embodiments may provide a trace input graphical user interface (GUI) object (or “trace input object”) for facilitating trace touch input. The trace input object may include a graphical object, such as a target or pencil-shaped object, presented on a touch screen that is configured to copy or otherwise represent trace touch input entered by a user such that the touch input results are completely visible to the user in substantially real-time as they are being entered by the user. In this manner, users are able to achieve efficient and accurate touch input results when entering trace touch input through a touch-based input device.

### CROSS REFERENCE TO RELATED APPLICATION

This application claims the benefit of U.S. Provisional Application No. 62/002,047 filed on May 22, 2014, the contents of which are incorporated by reference in their entirety as if fully set forth herein.

### BACKGROUND

Advances in touch screen technology have led to an increase in computing devices that operate primarily through touch input gestures. Touch-based applications that operate on such computing devices allow users to perform fundamental tasks, such as launching applications and scrolling, using more efficient and natural touch input methods that improve the overall user experience. Nonetheless, certain advanced functions within touch-enabled applications have not been updated to fully exploit touch input. For instance, object selection and content creation functions within conventional applications cannot be performed with adequate precision using touch input gestures. As such, advanced functions are prone to user error and inaccurate processing of user input. Thus, despite advances in software and touch screen technology, advanced functions ultimately remain constrained and low-productivity processes. Accordingly, it would be beneficial to provide solutions capable of efficiently and effectively receiving and processing touch input gestures for handling advanced functions beyond basic functions such as launching applications and scrolling.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a system for presenting trace output responsive to at least one touch input gesture may include a display, a touch-based input device, a processor operatively coupled to the display and the touch-based input device, and a non-transitory, computer-readable storage medium in operable communication with the processor. The computer-readable storage medium contains one or more programming instructions that, when executed, cause the processor to generate a trace input object configured to be presented on the display, receive input information based on the at least one touch input gesture received at the touch-based input device, the input information comprising manipulation information based on manipulation of the trace input object via the at least one touch input gesture, and generate trace output based on the manipulation information, the trace output being configured to be presented on the display.

In an embodiment, a computer-implemented method for presenting trace output responsive to user input may include, by a processor generating a trace input object configured to be presented on the display, receiving input information based on the at least one touch input gesture received at the touch-based input device, the input information comprising manipulation information based on manipulation of the trace input object via the at least one touch input gesture, and generating trace output based on the manipulation information, the trace output being configured to be presented on the display.

In an embodiment, a computer-readable storage medium having computer-readable program code configured to present trace output responsive to user input may include computer-readable program code configured to generate a trace input object configured to be presented on the display, computer-readable program code configured to receive input information based on the at least one touch input gesture received at the touch-based input device, the input information comprising manipulation information based on manipulation of the trace input object via the at least one touch input gesture, and computer-readable program code configured to generate trace output based on the manipulation information, the trace output being configured to be presented on the display.

### BRIEF DESCRIPTION OF THE DRAWINGS

The above and other objects of the present invention will become more readily apparent from the following detailed description taken in connection with the accompanying drawings.

FIG. 1 depicts an illustrative trace touch input system according to some embodiments.

FIGS. 2A and 2B depict an illustrative touch input GUI object according to some embodiments.

FIG. 3 depicts an alternative illustrative touch input GUI object according to some embodiments.

FIGS. 4A and 4B depict an illustrative wound management application using a trace input GUI object according to some embodiments.

FIG. 5 illustrates various embodiments of a computing device for implementing the various methods and processes described herein.

### DETAILED DESCRIPTION

The terminology used in the description is for the purpose of describing the particular versions or embodiments only, and is not intended to limit the scope.

The described technology generally relates to systems, methods, and computer-readable media for facilitating trace touch input through a touch input device of a computing system. In general, trace touch input includes touch input gestures that involve contacting an object, such as a human finger, with a touch screen device and moving the object on the screen while maintaining the contact with the touch screen device to draw, write, annotate, edit, or otherwise demarcate within an application operating on a computing system. For instance, trace touch input may include circling an object or writing text using a human finger, stylus, or the like on a touch screen device of a smartphone, tablet computing device, laptop or notebook computing device, touch-enabled monitor, or the like. When performing a writing motion using a writing implement on a surface (for instance, using pen on paper), the eyes of an individual naturally follow the tip of the writing implement and concentrate on the resulting marks as they are being made on the surface. This familiar and natural writing process allows the individual to form future marks based on previous marks viewed in substantially real-time. However, individuals performing similar writing or drawing motions using a human finger on a touch screen are not able to fully and adequately see the results of the trace touch input (for example, a line drawn on a touch screen) nor see the results in substantially real-time because the finger and hand block the view of the results as they are being formed. As such, users are uncertain about the touch input results because they are unable to see the results as they are being formed on the touch screen, which leads to inefficient and less precise touch input results.

Accordingly, some embodiments provide a trace input graphical user interface (GUI) object for facilitating trace touch input. In some embodiments, a trace input GUI object may include an object presented on a touch screen that is configured to copy, mirror, emulate, or otherwise represent trace touch input entered by a user on the touch screen such that the touch input results are completely visible to the user in substantially real-time as they are being entered by the user. In this manner, users are able to achieve efficient and accurate touch input results when entering trace touch input through a touch-based input device, such as a touch screen, of a computing system.

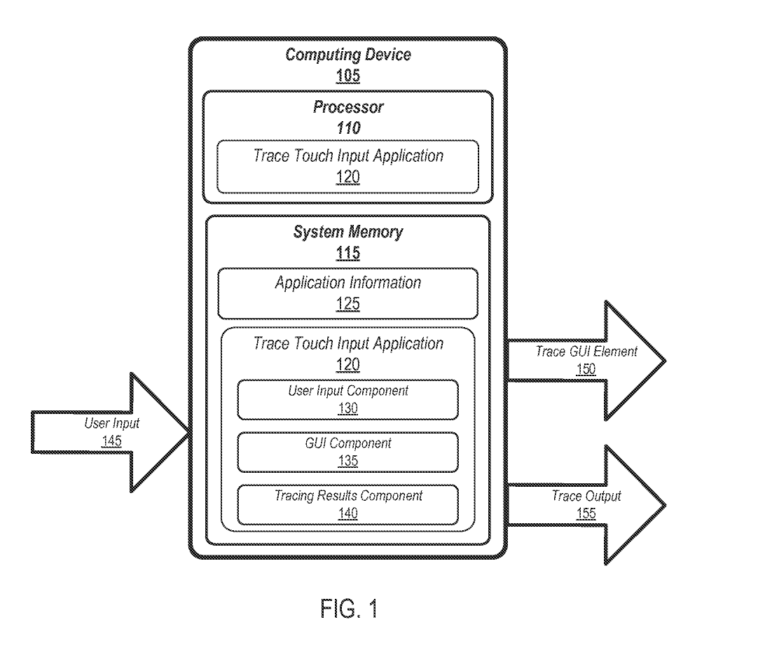

FIG. 1 depicts a trace touch input system according to some embodiments. As shown in FIG. 1, a trace touch input system may be implemented through a computing device 105 having a processor 110 and system memory 115. The computing device 105 may include server computing devices, personal computers (PCs), kiosk computing devices, mobile computing devices, laptop computers, mobile phone devices, such as smartphones, tablet computing devices, automotive computing devices, personal digital assistants (PDAs), or any other logic and/or computing devices now known or developed in the future.

The processor 110 may be configured to execute a trace touch input application 120. The trace touch input application 120 may include various modules, programs, applications, routines, functions, processes, or the like (“components”) to perform functions according to some embodiments described herein. In some embodiments, the trace touch input application 120 may include a user input component 130, a GUI component 135, and a tracing results component 140.

The trace touch input application 120 may be configured to receive input 145, for instance, through an input device operably coupled to the computing device 105. Non-limiting examples of input devices may include touch screens, mouse input devices, track pads, touch pads, track balls, keyboards, pointing devices, combinations thereof, and/or any other type of device capable of communicating user input to the electronic device 105. In some embodiments in which the input device is a touch screen or other touch-based input device, the user input 155 may be trace touch input in the form of touch gestures.

The user input component 130 may be configured to analyze user input 145 received by the trace touch input application 120, for example, through a touch-based input device. In some embodiments, the user input component 130 may generate input information based on user input received via an input device. For instance, the user input component 130 may generate input information based on trace touch input received via a touch-based input device. In some embodiments, the input information may include manipulation information relating to manipulation of the trace input GUI object (or “trace input object”) via the touch input gestures. The user input component 130 may analyze the user input 145, for example, as input information and/or manipulation information, to determine various input characteristics associated with the user input. In some embodiments, the input characteristics may include the location of the user input 145, such as the location of the user input on a screen (for example, X-Y coordinates of the user input). In some embodiments, the input characteristics may include the gesture type of the user input 145, such as single-touch or click, double-touch or click, select-and-hold, circle (for instance, drawing a circle around an object), or any other type of gesture capable of being detected by the trace touch input application 120. Non-limiting examples of other input characteristics may include duration, size, movement, active applications, active functions, previous user input 145 (for example, the immediately preceding user input), input context, and/or any other input characteristic capable of being detected by the trace touch input application 120.

The GUI component 135 may be configured to generate a trace input GUI object responsive to various types of user input 145. For example, the GUI component 135 may be configured to generate a trace input GUI object responsive to a user selecting an area on a touch screen and holding the select input (for instance, “sustained input”) for an input hold duration. For example, the input hold duration may be about 0.5 seconds, about 1 second, about 2 seconds, about 3 seconds, about 4 seconds, about 5 seconds, or any value or range between any two of these values). In some embodiments, the input hold duration may be a predetermined duration. In another example, the GUI component 135 may be configured to generate a trace input GUI object responsive to a user double-clicking (for instance, double-tapping a touch screen with a human finger) an area of an application window. The GUI component 135 may be configured to present the trace input GUI object on a display device operably coupled to the computing device 105. In some embodiments, the GUI component 135 may be configured to generate different types of trace input GUI objects based on the user input 145 (for instance, based on the input characteristics) and/or the context thereof. For example, the GUI component 135 may be configured to generate different types of trace input GUI objects based on user preferences, a selected object, an active application, an active application window, or the like. In some embodiments, the GUI component 135 may be configured to present the trace input GUI object responsive to activation of the trace touch input application 120.

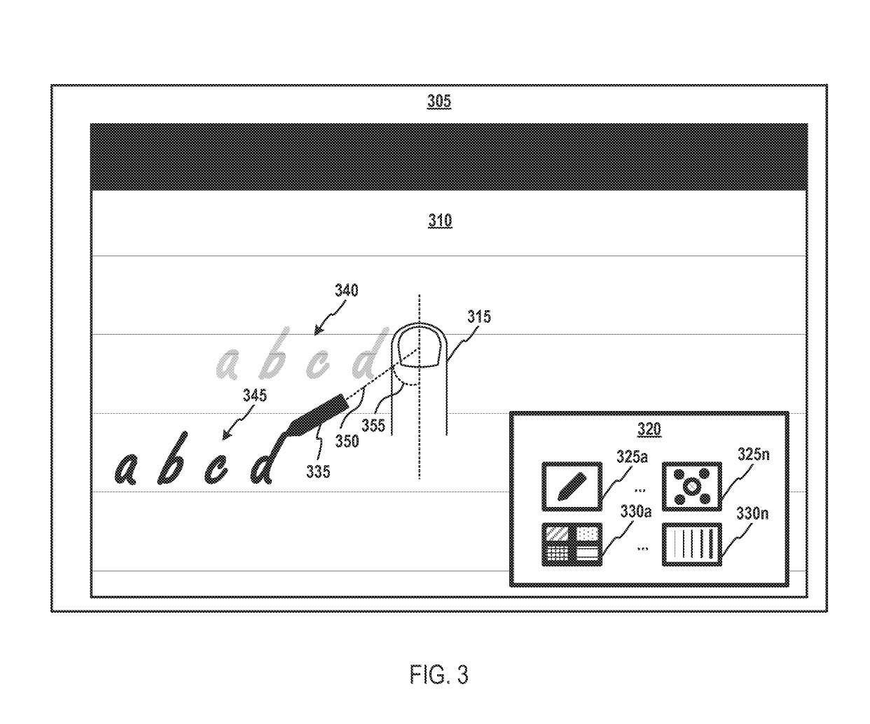

The tracing results component 140 may be configured to generate a trace output 155 responsive to user input 145 manipulating an active trace input GUI object. The trace output 155 may include a graphical representation of the trace user input 145 presented on a display operably coupled to the computing device 105. For example, the trace output 155 may include a line depicting the path of the trace user input 145 (for example, a “trace line”). In another example, the trace output 155 may include a dot or other visible object at each touch (or “tap”) location of the trace user input 145. In some embodiments, a trace input GUI object may be presented at the center of the trace user input 145 (for example, at the center of a human finger providing touch input on a touch screen) and the tracing results component 140 may be configured to present the trace output 155 at an output distance from and/or at an output angle relative to the center of the trace user input (see FIG. 3). In some embodiments, the output distance and/or the output angle may be a predetermined distance and/or predetermined angle. In some embodiments, the predetermined distance from and/or at a predetermined angle may be customized by a user (for instance, via an on-screen interface) or determined based on input context and/or input characteristics. In some embodiments, the output distance and/or output angle of the trace output 155 may be graphically represented using one or more elements, for example, as described herein. In this manner, a user may see where the trace output 155 corresponding to their touch input will be displayed on a screen. For instance, a graphical dot, point, circle, or other element may be displayed on a screen at the output distance and output angle in relation to the detected touch input.

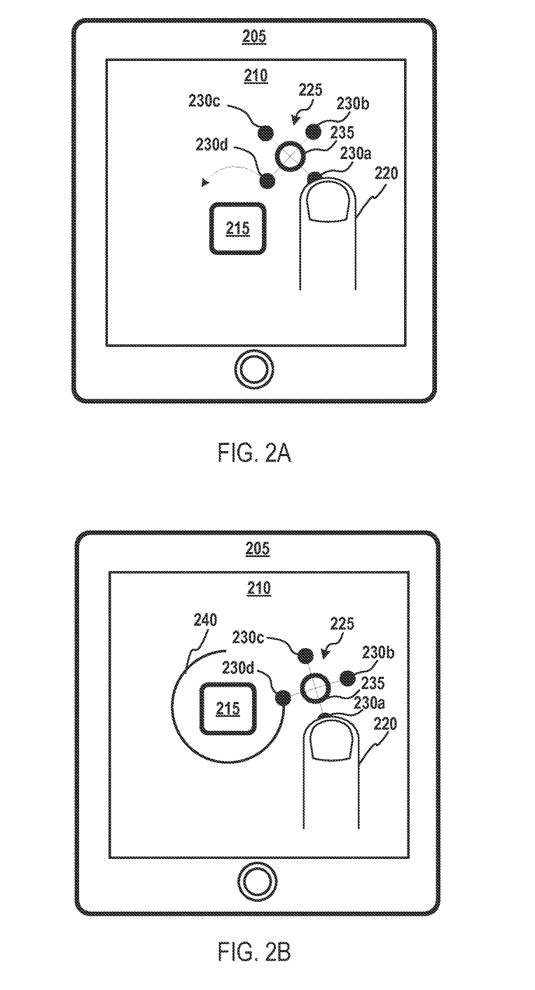

FIGS. 2A and 2B depict an illustrative touch input GUI object according to some embodiments. As shown in FIG. 2A, a computing device 205 may include a display 210 presenting an object 215 to a user, such as an image, an icon, or the like. A touch input GUI object 225 may be presented on the display 210. The touch input GUI object 225 may include various GUI object elements 230a-d, 235. For example, the touch input GUI object 225 may include a central element 235 having multiple extension elements 230a-d (“handlers”) extending therefrom. In some embodiments, the size, shape, and/or length of the extension elements 230a-d may be specified by a user, for instance, via a menu interface. In some embodiments using touch screen input, the size, shape, and/or length of the extension elements 230a-d may be automatically modified to correspond to the size of a user's finger based on an area of contact detected by the touch screen. One of the extension elements 230a may be selected by user input 220, such as touch input from a human finger on a touch screen. As shown in FIG. 2B, trace output 240 may be presented on the display 210 responsive to the user input 220 manipulating the touch input GUI object 225. For example, trace output 240 may be generated at extension element 230d as the touch input GUI object 225 is moved on the display 210 based on the user input 220 at extension element 230a. In FIG. 2B, the user input 220 operates to trace (for instance, draw a circle) around the object 215 using extension element 230a, thereby generating trace output 240 based on the path of extension element 230d. In general, the touch input GUI object 225 may allow a user to control the trace output 240 (for instance, a “trace line”) from a distance such that a view of the trace output is not blocked, for example, by a hand or finger of a user, as the trace output is being generated.

In some embodiments, one or more of the GUI object elements 230a-d, 235 may be designated to perform certain functions. For instance, one extension element 230a-d may be designated to generate trace output 240 (for example, a “tracing point”) based on the selection of another extension element (for example, a “selection point”). As depicted in FIGS. 2A and 2B, extension element 230d may be designated to generate trace output 240 responsive to selection of extension element 230a. In another example, extension element 230c may be designated to generate trace output 240 responsive to selection of extension element 230b. In some embodiments, one extension element 230a-d may be designated as the element for generating trace output 240, and the remaining extension elements may be designated for manipulation of the trace input GUI object 225. For example, the left-most extension element 230d may be designated as the element for generating trace output 240, and extension elements 230a-c may be designated for manipulation of the trace input GUI object 225 based on the user input 220.

In some embodiments, the trace touch input application 120 may be configured to present the trace input GUI object 225 within other applications executing on the computing device 105. For example, the trace input GUI object 225 may be presented within a word processing application, an image editing application, a spreadsheet application, a web browser application, a database application, a drawing application, or the like. In this manner, the trace input GUI object 225 may be used to accept input and provide trace output 240 within any application operating on the computing device 105.

FIG. 3 depicts a touch input GUI object according to some embodiments. As shown in FIG. 3, a menu interface 320 may be presented on a display 310 of a computing device 305. In some embodiments, the menu interface 320 may be presented based on user input 320. In some embodiments, the menu interface 320 may be presented based on activation of the trace touch input application 120 on the computing device 305. The menu interface 320 may provide various options, including, without limitation, touch input GUI objects 325a-n and trace output characteristics 330a-n. A user may use the menu interface 320 to select a touch input GUI object 325a-n, including, without limitation, a “pencil-form” GUI object or a “target-form” GUI object. A user may also use the menu interface 320 to specify trace output characteristics 330a-n, including, without limitation, color, thickness, dashes, symbols, transparency, or the like. In some embodiments, the menu interface 320 may include an option to specify and/or modify the size of a touch input GUI object. In this manner, a user may size or re-size a touch input GUI object to correspond to the size of the user's finger. In some embodiments using touch screen input, the size of a touch input GUI object may be automatically modified to correspond to the size of a user's finger based on an area of contact detected by the touch screen.

In some embodiments, the touch input GUI object 335 may be configured to be positioned and to generate the trace output 345 at an output distance 350 from and at an output angle 355 relative to the touch input 315. In some embodiments, the output distance 350 may be about 0.5 millimeters, about 1 millimeter, about 2 millimeters, about 3 millimeters, about 5 millimeters, and any value or range between any two of these values (including endpoints). In some embodiments, the output angle 355 may be of about 10°, about 15°, about 20°, about 30°, about 45°, about 60°, about 90°, and any value or range between any two of these values (including endpoints).

In FIG. 3A, a “pencil-form” GUI object 335 has been activated that may operate to generate trace output 345 that mimics the touch input 315 at the output distance 350 and output angle 355. For example, the actual user input 315 may include the drawing of letters 340, such as within a note application. The letters 340 may not be graphically represented on the display 310. Instead, the trace output 355 may present the letters 340 as trace output 345 at the output distance 350 and/or output angle 355 from the touch input 315.

The trace input GUI objects described and depicted herein, such as trace input GUI object 225 depicted in FIGS. 2A and 2B and trace input GUI object 335 depicted in FIG. 3, are non-limiting and are provided for illustrative purposes only. A trace input GUI object may have any form, size, shape, elements, and/or other characteristics capable of operating according to some embodiments.

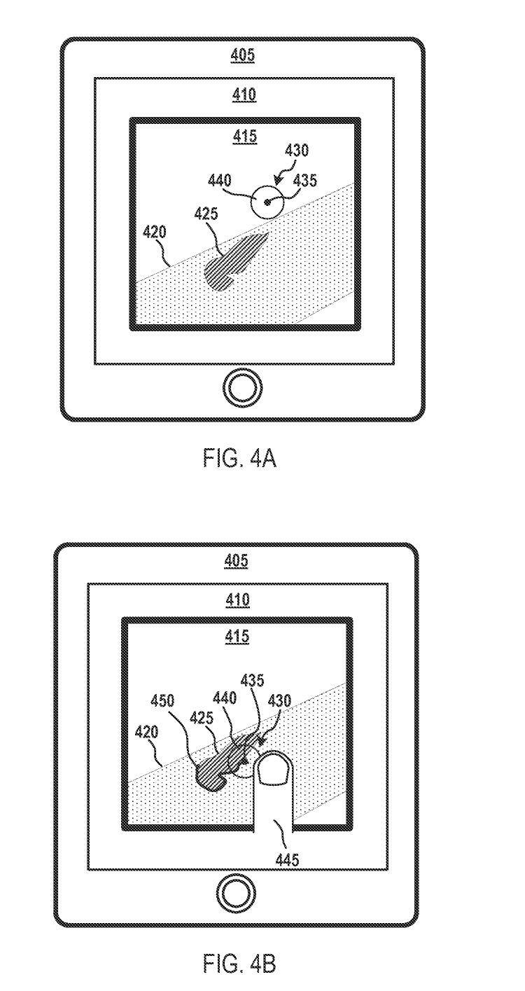

FIGS. 4A and 4B depict an illustrative wound management application using a trace input GUI object according to some embodiments. As shown in FIG. 4, a wound management application operating on a computing device 405 may be configured to provide an application interface 410. In some embodiments, the computing device 405 may include a tablet computing device, smartphone, or other computing device configured to receive touch input through a touch-enabled screen. The wound management application may generally be configured to allow a user to provide images of a wound to a healthcare provider, for example, so that the healthcare provider may make a healthcare assessment of the wound and/or monitor healing of the wound. In some embodiments, the wound management application may be configured to provide functionality allowing a patient to upload an image of a wound and to annotate the image of the wound. Illustrative annotations include, without limitation, circling the wound, drawing on the image, providing textual comments, inserting symbols, providing measurement information, and/or color comparison objects, and/or any other processes for editing an image known to those having ordinary skill in the art. A user may take a picture of a portion of the body having a wound and may upload or otherwise provide a digital version of the picture to the wound management application. The digital version of the picture may be presented as a wound image 415 through the application interface 410. As depicted in FIG. 4A, the wound image 415 may include a portion of an arm 420 and a wound 425 on the arm, such as a cut, lesion, sore, infection, discoloration, or the like.

The wound management application may provide functionality for a user to trace the wound 425. Using conventional technology for receiving and processing touch screen input, a view of the wound edges and the tracing line thereof on a touchscreen would be blocked by the hand and fingers of the user as the user traced around the wound 425 with their finger. As such, a trace input GUI object (or “proximity tracing handler” (PTH)) 430 may be presented on the display 410 to facilitate the efficient and accurate tracing of the wound 425. The PTH 430 may be circular or substantially circular and may include a tracing point 435 and an outer edge region 440, which generally includes the area within the PTH outside of the tracing point. As shown in FIG. 4B, user input 445 may select (or “grab”) any portion of the outer edge region 440 to manipulate the PTH 430. As the user input 445 manipulates the PTH 430, a trace output 450 (for example, a “trace line”) may be generated at the path covered by the center point 435. The user may save the wound image 415 with the trace output 450 and send to a healthcare professional for analysis.

The technical solutions provided according to some embodiments to the problems with user input, particularly touch trace input on a touch-based input device, using conventional systems and methods are necessarily implemented in software and other computer technology because they overcome problems specifically arising in the realm of software and computer technology.

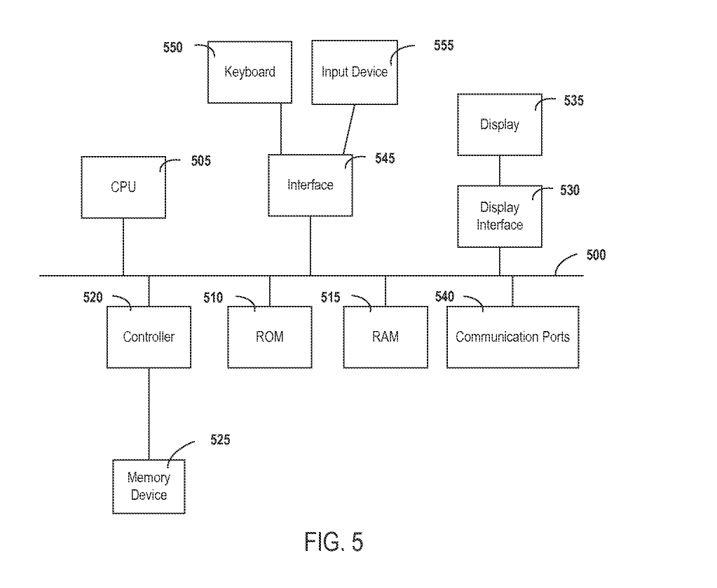

FIG. 5 depicts a block diagram of exemplary internal hardware that may be used to contain or implement the various computer processes and systems as discussed above. A bus 500 serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an exemplary processing device, computing device or processor as such terms are used within this disclosure. Read only memory (ROM) 510 and random access memory (RAM) 515 constitute exemplary memory devices.

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices. Additionally, the memory devices 525 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any of the functional steps as described above may be stored in the ROM 530 and/or the RAM 535. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 545 may permit information from the bus 500 to be displayed on the display 535 in audio, visual, graphic or alphanumeric format. Communication with external devices may occur using various communication ports 540. An exemplary communication port 540 may be attached to a communications network, such as the Internet or a local area network.

The hardware may also include an interface 545 which allows for receipt of data from input devices such as a keyboard 550 or other input device 555 such as a mouse, a joystick, a touch screen, a remote control, a pointing device, a video input device and/or an audio input device.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to”). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, or the like. As a non-limiting example, each range discussed herein can be readily broken down into a lower third, a middle third, and an upper third. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A system for presenting trace output responsive to at least one touch input gesture, the system comprising:
a display;
a touch-based input device;
a processor operatively coupled to the display and the touch-based input device; and
a non-transitory, computer-readable storage medium in operable communication with the processor, wherein the computer-readable storage medium contains one or more programming instructions that, when executed, cause the processor to:
generate a trace input object configured to be presented on the display,
receive input information based on the at least one touch input gesture received at the touch-based input device, the input information comprising manipulation information based on manipulation of the trace input object via the at least one touch input gesture, and
generate trace output based on the manipulation information, the trace output being configured to be presented on the display.

2. The system of claim 1, wherein the input information comprises at least one input characteristic, the at least one input characteristic comprising at least one of location of trace touch input, gesture type, duration, size, movement, active applications, active functions, previous user input, and input context.

3. The system of claim 2, wherein the trace input object is generated based on the at least one input characteristic.

4. The system of claim 1, wherein the trace output is presented on the display at an output distance and an output angle from the at least one touch input gesture.

5. The system of claim 1, wherein the touch-based input device comprises a touch screen and the at least one touch input gesture comprises touch gestures from a human finger.

6. The system of claim 1, wherein the trace input object is generated responsive to the at least one touch input gesture being input at a particular location.

7. The system of claim 1, wherein the trace input object is generated responsive to the at least one touch input gesture being sustained for an input hold duration.

8. The system of claim 1, wherein the trace output comprises a trace line depicting a path of the at least one input gesture.

9. A computer-implemented method for presenting trace output responsive to at least one touch input gesture, the method comprising, by a processor:
generating a trace input object configured to be presented on the display;
receiving input information based on the at least one touch input gesture received at the touch-based input device, the input information comprising manipulation information based on manipulation of the trace input object via the at least one touch input gesture; and
generating trace output based on the manipulation information, the trace output being configured to be presented on the display.

10. The method of claim 9, wherein the input information comprises at least one input characteristic, the at least one input characteristic comprising at least one of location of trace touch input, gesture type, duration, size, movement, active applications, active functions, previous user input, and input context.

11. The method of claim 10, wherein the trace input object is generated based on the at least one input characteristic.

12. The method of claim 9, wherein the trace output is presented on the display at an output distance and an output angle from the at least one touch input gesture.

13. The method of claim 9, wherein the touch-based input device comprises a touch screen and the at least one touch input gesture comprises touch gestures from a human finger.

14. The method of claim 9, wherein the trace input object is generated responsive to the at least one touch input gesture being input at a particular location.

15. The method of claim 9, wherein the trace input object is generated responsive to the at least one touch input gesture being sustained for an input hold duration.

16. The method of claim 9, wherein the trace output comprises a trace line depicting a path of the at least one input gesture.

17. A computer-readable storage medium having computer-readable program code configured to present trace output responsive to user input, the computer-readable program code comprising:
computer-readable program code configured to generate a trace input object configured to be presented on the display;
computer-readable program code configured to receive input information based on the at least one touch input gesture received at the touch-based input device, the input information comprising manipulation information based on manipulation of the trace input object via the at least one touch input gesture; and
computer-readable program code configured to generate trace output based on the manipulation information, the trace output being configured to be presented on the display.

18. The computer-readable storage medium of claim 17, further comprising computer-readable program code configured to generate the trace input object based on at least one input characteristic.

19. The computer-readable storage medium of claim 17, further comprising computer-readable program code configured to present the trace output on the display at an output distance and an output angle from the at least one touch input gesture.

20. The computer-readable storage medium of claim 17, further comprising computer-readable program code configured to generate the trace input object generated responsive to the at least one touch input gesture being input at a particular location.
